(19) United States
(12) Patent Application Publication
(10) Pub. No.: US 2005/0206976 A1
(43) Pub. Date: Sep. 22, 2005

(54) Method for detecting deterioration of an exposure lamp

(75) Inventor: Susumu Hakamada, Yokohama-shi (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/804,205

(22) Filed: Mar. 19, 2004

(51) Int. Cl. H04N 1/04

(52) U.S. Cl. 358/509; 358/474

(57) ABSTRACT

A reference white board is illuminated by an exposure lamp, and an image at a region illuminated is converted into an image signal by a photoelectric conversion device. The image signal output from the photoelectric conversion device is amplified at a predetermined amplification factor. By comparing the level of the amplified image signal with a reference value, deterioration of the exposure lamp is detected.

### BACKGROUND OF THE INVENTION

The present invention relates to an image reading apparatus for reading an image on an original and an image forming apparatus such as a copying machine having an image reading apparatus, and in particular, to a technique of exactly detecting the lifetime of an exposure lamp for illuminating an original at the time of reading an image on the original.

Generally, the image reading apparatus includes a first carriage having a light source and a first mirror, a second carriage having second and third mirrors, a lens and a photoelectric conversion device such as a CCD. When a document is read by the image reading apparatus, the original placed on a platen glass is illuminated by the light source of the first carriage which moves in the sub-scanning direction.

Reflected light from the original is reflected on the first to third mirrors, and is concentrated by the lens and guided to the photoelectric conversion device. At that time, the second carriage moves such that the optical path length of the reflected light from the original to the CCD is constant, in a direction which is the same as the moving direction of the first carriage and at a half-speed of that of the first carriage. The CCD sensor scans the incident reflected light in the main scanning direction. As a result, an image on the original of one scanning line is converted into an electrical signal. By scanning the original in the sub-scanning direction by using the first and second carriages, image data corresponding to a range all over the image on the original is provided from the CCD sensor.

In this way, in the image reading apparatus having a photoelectric conversion device, the lifetime of an exposure lamp for reading an image has been determined from only the number of sheets of the read originals (lighting time). Accordingly, because the actual deterioration (reduction in quantity of light) of the exposure lamp cannot be determined, there are cases that image deterioration arises due to the irregularity in the lifetimes of respective exposure lamps.

### SUMMARY OF THE INVENTION

An object of the present invention is to provide an image reading apparatus in which there is no case that image deterioration arises due to the irregularity in the lifetimes of exposure lamps.

In order to achieve the above object, according to one aspect of the present invention, there is provided an image reading apparatus comprising: an exposure lamp; a photoelectric conversion device which converts an image at a region illuminated by the exposure lamp into an image signal; a variable amplifier which amplifies the image signal output from the photoelectric conversion device at an instructed amplification factor; and a detecting unit which compares a level of the image signal obtained from the variable amplifier with a reference value and detects deterioration of the exposure lamp when a reference white surface is illuminated by the exposure lamp, with the amplification factor of the variable amplifier being set to a predetermined value.

### BRIEF DESCRIPTION OF THE DRAWINGS

FIG. 1 is a diagram showing a configuration of an image reading apparatus to which the present invention is applied.

FIG. 2 is a block diagram showing a configuration of a control system of the image reading apparatus.

FIG. 3 is a diagram shown by extracting a configuration of an image signal route from the circuit configuration shown in FIG. 2.

FIG. 4 is a flowchart showing operations according to a first embodiment of the present invention.

FIG. 5 is a flowchart showing operations according to a second embodiment of the present invention.

### DETAILED DESCRIPTION OF THE PREFERRED EMBODIMENTS

Embodiments of the present invention will be described in detail with reference to the drawings.

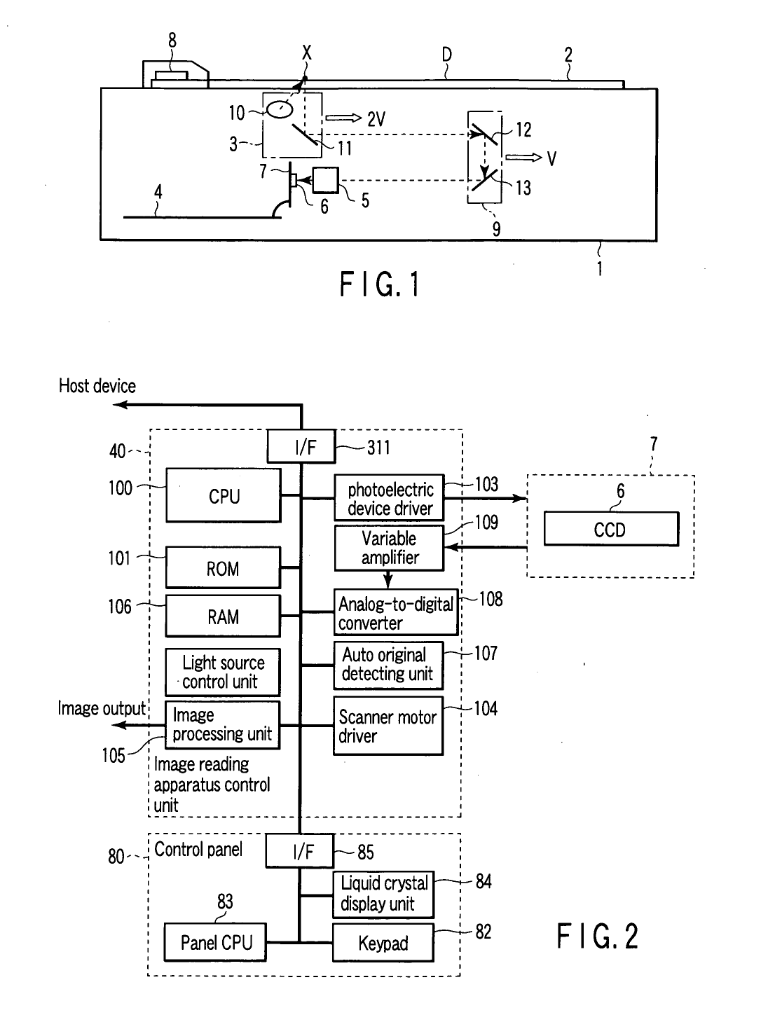

FIG. 1 is a diagram showing a configuration of an image reading apparatus 1 to which the present invention is applied.

An original is placed such that the image surface side thereof directs downward on a platen glass 2. When a start button (not shown) is pressed, or a start instruction is received from a host device, an exposure lamp 10 using a xenon light source, a cold-cathode tube, or a halogen lamp, etc., is turned on, and the original is illuminated. Reflected light from a reading position X of the original D is reflected on a first mirror 11, a second mirror 12, and a third mirror 13. The reflected light from the third mirror 13 is incident on a condensing lens 5, and an image is formed on a light receiving surface of a photoelectric conversion device 6 configured from a CCD or the like. The photoelectric conversion device 6 is provided on a photoelectric conversion device control substrate 7, and scans the original in the main scanning direction.

An electric circuit for processing an image signal output from the photoelectric conversion device 6, and a processing circuit (an image reading apparatus control unit 40 which will be described later) such as a CPU which controls overall the image reading apparatus 1 are mounted on the image reading apparatus control substrate 4.

When the image on the original is read, a first carriage 3 composed of the exposure lamp 10 and the first mirror 12, and a second carriage 9 composed of the second mirror 12 and the third mirror 13 are moved in the directions of the arrows in the drawing. In accordance therewith, the original is scanned in a sub-scanning direction (the right direction in the drawing). At that time, the moving speed of the first carriage 3 is set to be double that of the second carriage 9 such that an optical path length (a focal length) from the original to the photoelectric conversion device is constant.

FIG. 2 is a block diagram showing a configuration of a control system of the image reading apparatus 1. The image reading apparatus 1 includes the image reading apparatus control unit 40 and a control panel 80.

A CPU 100 in the image reading apparatus control unit 40 controls overall the image reading apparatus 1 in accordance with a control program stored in a ROM 101, and uses a RAM 106 in order to temporarily store data. The CPU 100 carries out communication with a host device such as a personal computer or the like via an interface 311. A photoelectric conversion device driver 103 transmits various driving signals to the photoelectric conversion device 6. An image signal outputted from the photoelectric conversion device 6 is amplified by a variable amplifier 109, and is digitized by the analog-to-digital converter 108 and provided to an image processing unit 105. A scanner motor driver 104 controls the rotations of a motor which moves the first and second carriages or the like. An auto original detecting unit 107 detects whether the original is placed on the platen glass 2, or a size of the original placed thereon.

The image processing unit 105 includes a memory for temporarily storing the image signal from the photoelectric conversion device 6. Further, the image processing unit 105 includes a shading correction circuit for correcting fluctuations in an output signal level from the photoelectric conversion device 6 due to, for example, an ambient temperature change, and a gamma control circuit. Moreover, the image processing unit 105 carries out image processing such as trimming, masking, enlargement/reduction processing, resolution conversion, compression/incompression processing on image, and the like, with respect to the corrected image data.

A panel CPU 83 of the control panel 80 controls overall the control panel 80, and carries out communication with the CPU 100 via a control panel interface 85. A screen for setting original reading conditions, or the like is displayed on a liquid crystal display unit 84. The panel CPU 83 receives the data relating to the original reading conditions input from a user via a keypad 82, transmits the input data to the image reading apparatus control unit 40 and displays it on the liquid crystal display unit 84.

Next, a first embodiment of a method for detecting deterioration of an exposure lamp of the present invention will be described in detail.

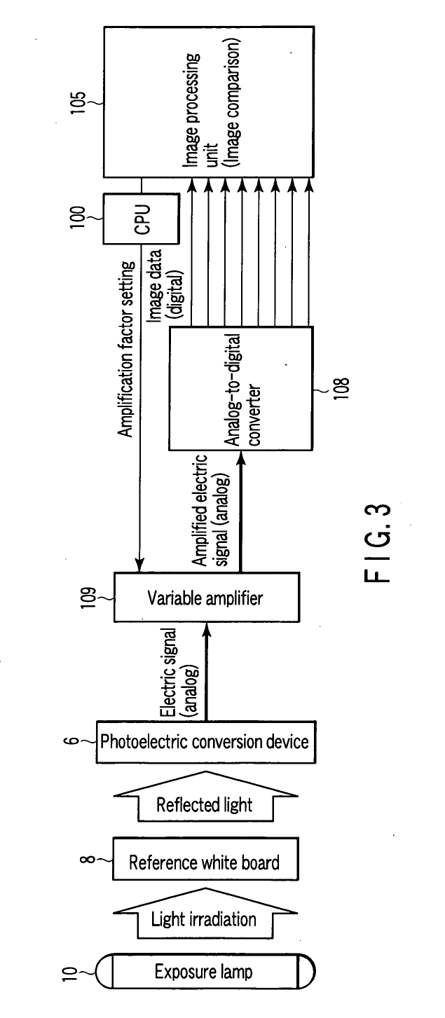

The image reading apparatus 1 determines an amplification factor of the variable amplifier 109 for amplifying an electrical signal (image signal) output from the photoelectric conversion device 6 at the time of turning the power source on. FIG. 3 is a diagram shown by extracting a configuration of an image signal route from the circuit configuration shown in FIG. 2.

At the time of turning the power source on, the carriage 3 is moved to a position of a reference white board 8. The exposure lamp 10 is turned on, the reference white board 8 is irradiated with light, and the reflected light therefrom is taken into the photoelectric conversion device 6. The photoelectric conversion device 6 photoelectrically converts the reflected light from the reference white board 8, and provides the image signal. The variable amplifier 109 amplifies the image signal, and the amplified image signal is converted into image data which is a digital signal by the analog-to-digital converter 108. The image data is taken into the image processing unit 105.

The image processing unit 105 compares the taken-in image data (image signal on the reference white board) with a reference value. On the basis of the compared result, the CPU 100 varies the amplification factor of the variable amplifier 109 such that the image data is made to approximate to the reference value. When the image data is converged to the reference value by repeating the operation, a final amplification factor is determined. The present invention provides a method for exactly detecting the lifetime of the exposure lamp 10 by using the configuration.

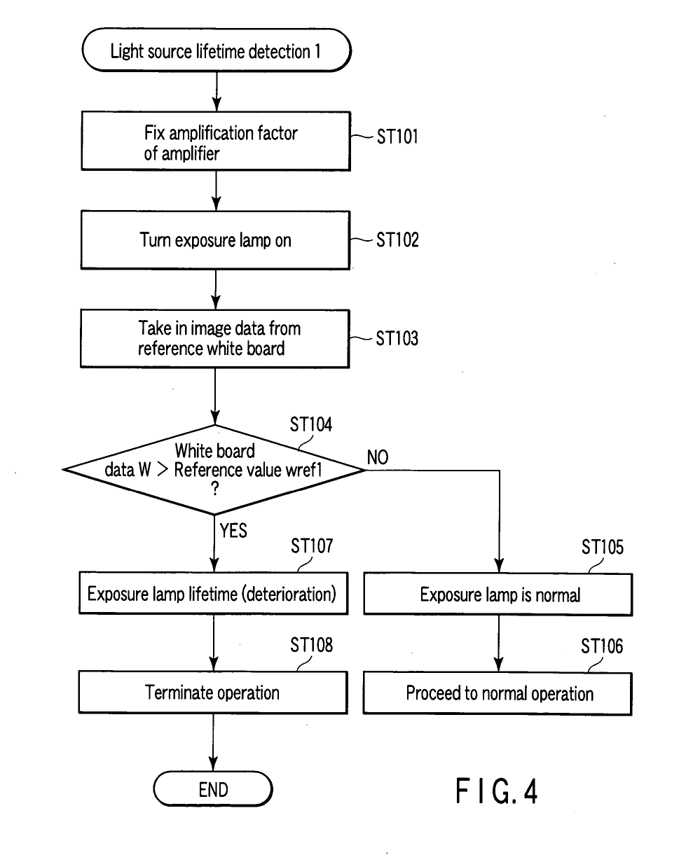

FIG. 4 is a flowchart showing the operations relating to one embodiment of the present invention.

The CPU 100 fixes the amplification factor of the variable amplifier 109 to a predetermined value (ST101), turns the exposure lamp 10 on (ST 102), and irradiates light on the reference white board 8. The reflected light from the reference white board 8 is taken into the photoelectric conversion device 6, and is converted into an image signal. The image signal is amplified at the variable amplifier 109, and is digitized by the analog-to-digital converter 108 to generate image data, and the image data is taken into the image processing unit 105 (ST 103).

The CPU 100 compares the image data of the reference white board 8 (hereinafter, white board data W) taken into the image processing unit 105 with a reference value Wref1 (ST104). The reference value Wref1 is a valued of data obtained from the analog-to-digital converter 108 when the reference white board is illuminated by an exposure lamp which is the same type as the exposure lamp 10 and which has reached a lifetime thereof, with the amplification factor of the variable amplifier 109 being fixed to the predetermined value. The reference value Wref1 is also a value stored in advance in the ROM 101 or the like.

When the value of the white board data W becomes less than or equal to the reference value Wref1 (NO in ST104), the CPU 100 determines that the exposure lamp 10 has reached the lifetime thereof (has deteriorated) (ST107), terminates the operation of the original reading apparatus (ST108), and displays, for example, a warning message on the control panel. In this way, the CPU 100 detects a deterioration of the exposure lamp 10. Here, when the extent of the deterioration is small (when the reference value Wref1 is a value which is such that even a slight deterioration can be detected), such a message to urge the user to replace the exposure lamp may be displayed on the control panel, and the operation may be continued.

When the value of the white board data W is larger than the reference value Wref1 (YES at ST104), the CPU 100 determines that the exposure lamp 10 is normal (ST105), and proceeds to a normal reading operation (ST106). Here, the lifetime of the exposure lamp expresses, for example, the sum of the lighting time from the lighting start until the time when a light-emission amount is less than the rating.

Conventionally, the lifetime of the exposure lamp 10 is determined from the number of sheets of read originals (lighting time of the exposure lamp 10). Therefore, when the quantity of light is reduced, even when the lighting time is less than or equal to the lifetime, due to the irregularity in the lifetime of the exposure lamp 10, there are cases that a poor image is generated. In accordance with the present invention, the actual lifetime of the exposure lamp 10 can be determined, and image deterioration can be prevented. Further, conventionally, because it is determined from the lighting time that the lifetime has been reached even if the exposure lamp 10 has not reached the lifetime (has not deteriorated), even the available exposure lamp 10 is determined so as to have reached the lifetime thereof. In the present invention, because a deterioration in the quantity of light of the exposure lamp 10 can be determined, even when the lighting time is greater than or equal to the lifetime due to the irregularity in the lifetimes, unless the quantity of light is reduced, it is possible to extend the lifetime of the exposure lamp 10. Moreover, in accordance with the present invention, by fixing the amplification factor of the variable amplifier 109 to a predetermined value, it is possible to determine the lifetime of the exposure lamp under the same condition at all times.

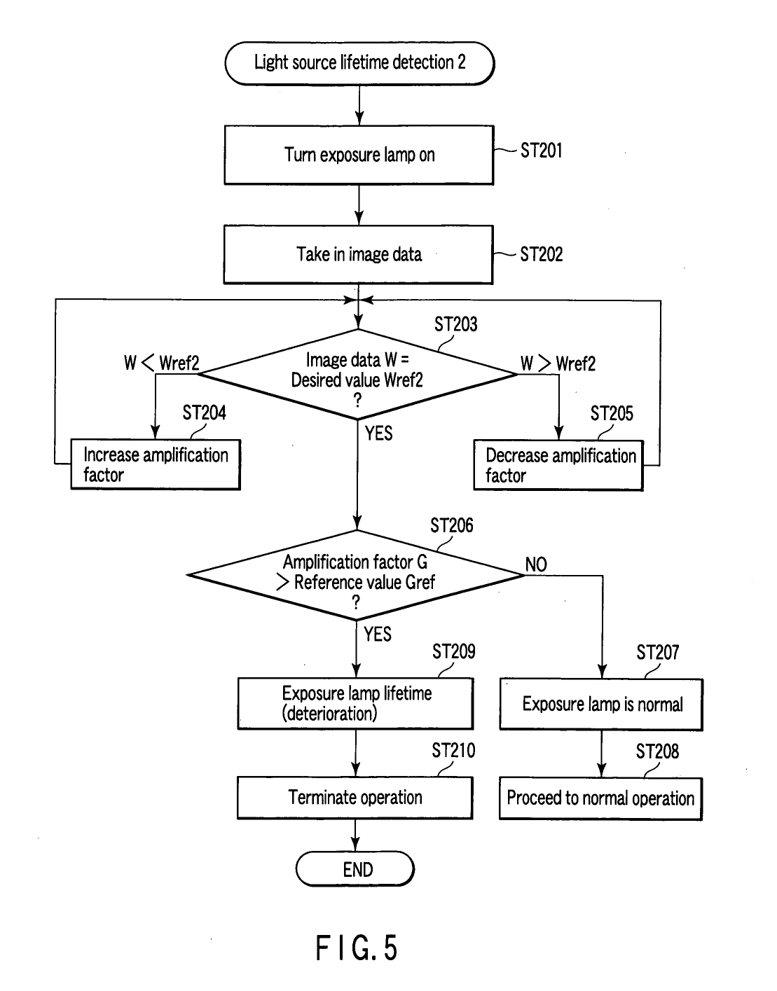

Next, a second embodiment of the present invention will be described. FIG. 5 is a flowchart showing the operations of the second embodiment.

At the time of turning the power source of the image reading apparatus 1 on, the CPU 100 turns the exposure lamp 10 on (ST201), and irradiates light on the reference white board 8. The reflected light from the reference white board 8 is taken into the photoelectric conversion device 6, and is converted into an image signal. The image signal is amplified by the variable amplifier 109, the amplified image signal is digitized by the analog-to-digital converter 108, and image data (white board data W) is generated and is taken into the image processing unit 105 (ST202).

Next, the CPU 100 determines an amplification factor of the variable amplifier 109. Namely, the CPU 100 adjusts the amplification factor of the variable amplifier 109 such that the taken-in white board data W is set to a desired value Wref2. When the white board data W is less than the desired value Wref2, the amplification factor is increased (ST204), and when the white board data W is greater than the desired value Wref2, the amplification factor is decreased (ST205).

When the white board data W becomes substantially equal to the desired value Wref2, (YES in ST203), the CPU 100 compares an amplification factor G at that time with a reference value Gref for the amplification factor (ST206). The reference value Gref is an amplification factor of the variable amplifier 109 for setting a level of the image signal obtained from the variable amplifier 109 to the above-described desired value Wref2 when the reference white board is illuminated by the exposure lamp which is the same type as the exposure lamp 10 and which has reached the lifetime thereof. The reference value Gref is further a value stored in advance in the ROM 101 or the like.

When the amplification factor G is greater than the reference value Gref (YES in ST206), the CPU 100 determines that the exposure lamp has reached the lifetime thereof (has deteriorated) (ST209), terminates the operation (ST210), and displays a warning message on the control panel. In this way, the CPU 100 detects a deterioration of the exposure lamp 10. As described above, when the extent of the deterioration is small (when the reference value Gref is a value by which even a slight deterioration can be detected), a message to urge the user to replace the exposure lamp may be displayed on the control panel, and the operation may be continued. When the amplification factor G is less than the reference value Gref (NO in ST206), the CPU 100 determines that the exposure lamp is normal (ST207), and proceeds to a normal reading operation (ST208).

In this way, in accordance with the present invention, by using the amplification factor, which is adjusted in accordance with the actual reading condition, of the variable amplifier 109, it is possible to more exactly determine the lifetime of the exposure lamp.

The above description is the embodiments of the present invention, and the apparatus and the method of the present invention are not limited thereby, and various modified examples can be implemented. Such modified examples are included in the present invention. Further, an apparatus and a method which are configured by appropriately combining the components, the functions, the features, or the steps of the method in the respective embodiments, are included in the present invention. In addition, it is considered obvious that the present invention can be applied to an image forming apparatus which has an image reading apparatus and in which an image is formed on a paper on the basis of image data obtained from the image reading apparatus.

1. An image reading apparatus comprising:
an exposure lamp;
a photoelectric conversion device which converts an image at a region illuminated by the exposure lamp into an image signal;
a variable amplifier which amplifies the image signal output from the photoelectric conversion device at an instructed amplification factor; and
a detecting unit which compares a level of the image signal obtained from the variable amplifier with a reference value and detects deterioration of the exposure lamp when a reference white surface is illuminated by the exposure lamp, with the amplification factor of the variable amplifier being set to a predetermined value.

2. An image reading apparatus according to claim 1, wherein the reference value is a value of data obtained from the variable amplifier when the reference white surface is illuminated by the exposure lamp which has reached a lifetime thereof with the amplification factor of the variable amplifier being set to the predetermined value.

3. An image reading apparatus according to claim 2, further comprising a termination unit which terminates operation the apparatus when the deterioration is detected.

4. An image reading apparatus according to claim 1, further comprising a display unit which displays a message to urge replacement of the exposure lamp when the deterioration is detected.

5. An image reading apparatus comprising:
an exposure lamp;
a photoelectric conversion device which converts an image at a region illuminated by the exposure lamp into an image signal;
a variable amplifier which amplifies the image signal output from the photoelectric conversion device at an instructed amplification factor;
an amplification factor adjusting unit which adjusts the amplification factor of the variable amplifier such that a level of the image signal obtained from the variable amplifier is a predetermined level when a reference white surface is illuminated by the exposure lamp; and
a detecting unit which compares the amplification factor of the variable amplifier adjusted by the amplification factor adjusting unit with a reference amplification value, and which detects deterioration of the exposure lamp.

6. An image reading apparatus according to claim 5, wherein the reference amplification value is an amplification factor of the variable amplifier in which the level of the image signal obtained from the variable amplifier is the predetermined level when the reference white surface is illuminated by an exposure lamp which is the same type as the exposure lamp and which has reached a lifetime thereof.

7. An image reading apparatus according to claim 6, further comprising a termination unit which terminates operation of the apparatus when the deterioration is detected.

8. An image reading apparatus according to claim 5, further comprising a display unit which displays a message to urge replacement of the exposure lamp when the deterioration is detected.

9. A method for detecting deterioration of an exposure lamp, comprising:
illuminating a reference white surface by an exposure lamp;
converting an image at a region illuminated by the exposure lamp into an image signal by a photoelectric conversion device;
amplifying the image signal output from the photoelectric conversion device at a predetermined amplification factor; and
comparing a level of the amplified image signal with a reference value, and detecting deterioration of the exposure lamp.

10. A method for detecting deterioration of an exposure lamp, according to claim 9, wherein the reference value is a value of data obtained by setting the amplification factor of the variable amplifier to the predetermined value when the reference white surface is illuminated by an exposure lamp which is the same type as the exposure lamp and which has reached a lifetime thereof.
